(19) United States
(12) Patent Application Publication
(10) Pub. No.: US 2006/0170387 A1
(43) Pub. Date: Aug. 3, 2006

(54) Method and control circuit for triggering an electric motor with the aid of a pulse width modulation signal

(76) Inventors: Stefan Koch, Kappelrodeck (DE); Nikolas Haberl, Lauf (DE)

Correspondence Address: KENYON & KENYON LLP, ONE BROADWAY, NEW YORK, NY, 10004, US

(21) Appl. No.: 10/542,915

(22) PCT Filed: Dec. 10, 2003
(86) PCT No.: PCT/DE03/04068

§ 371 Date: Feb. 7, 2006

(30) Foreign Application Priority Data
Jan. 20, 2003 (DE) 103 01 821.2

(51) Int. Cl. G05B 11/28

(52) U.S. Cl. 318/599

(57) ABSTRACT

A method for triggering an electric motor with a pulse width modulation signal, the pulse width modulation signal having a triggering frequency and a pulse duty factor, the electric motor being controlled as a function of the pulse duty factor via a supply voltage line, at least one electrical component being provided for low-pass filtering of the voltage fluctuations caused on the supply voltage line by the pulse width modulation signal, wherein the triggering frequency of the pulse width modulation signal is modified as a function of the pulse duty factor.

### FIELD OF THE INVENTION

The invention concerns a method for triggering an electric motor with a pulse width modulation signal. The invention further concerns a control circuit for triggering an electric motor, the electric motor being triggered with the aid of a pulse width modulation signal.

### BACKGROUND INFORMATION

For stepless control of electric motors, the latter are often operated with a pulse width modulated voltage. The pulse width modulated voltage is applied to the electric motor with the aid of a switching device to which a pulse width modulation signal is applied. The pulse width modulation signal has a pulse duty factor with which the voltage at the electric motor, and therefore the rotation speed of the motor, can be controlled.

The pulse width modulated voltage for triggering the electric motor has the disadvantage that interference is caused thereby on the supply voltage lines to which the electric motor is connected. A low-pass filter is therefore usually connected to the supply voltage lines in order to smooth the voltage.

The low-pass filter has a capacitor and/or a choke coil, whose power dissipation values depend on the pulse duty factor of the triggering frequency. The power dissipation in the components of the low-pass filter usually rises with an increase in frequency. On the other hand, an increase in the triggering frequency of the pulse width modulation signal also results in improved filtering of the line-conducted interference caused in the supply voltage lines. This line-conducted interference is measured in the high-frequency region, and must not exceed specific maximum limits.

### SUMMARY OF THE INVENTION

It is the object of the present invention to make available a method and a control circuit for triggering an electric motor with which the line-conducted interference can be kept low and below a specific maximum limit, and in which at the same time the power dissipation at the components that are connected to the supply voltage lines does not exceed a maximum value.

According to a first aspect of the present invention, a method for triggering an electric motor with a pulse-width modulation signal is provided. The pulse width modulation signal has a triggering frequency and a pulse duty factor. The electric motor is controlled as a function of the pulse duty factor, and supplied with power via a supply voltage line. At least one electrical component is provided for low-pass filtering of the voltage fluctuations caused on the supply voltage line by the pulse width modulation signal. According to the present invention, the triggering frequency of the pulse width modulation signal is modified as a function of the pulse duty factor.

Provision can thereby be made for triggering of the electric motor to be accomplished in such a way that for each possible pulse duty factor, the triggering frequency is selected in order to obtain a desired power dissipation and a desired amount of line-conducted interference. The triggering frequency is preferably adapted as a function of the pulse duty factor in such a way that the maximum permissible power dissipation in the electrical component is not exceeded. At the same time, provision is preferably made for the selected triggering frequency to be as high as possible, in order to achieve better filtering of the line-conducted high-frequency interference on the supply voltage line.

The advantage of the method according to the present invention is that the triggering frequency is selected in each case so that the voltage dissipation at each of the electrical components for low-pass filtering is not exceeded. Because the power dissipation increases with increasing frequency, in order to limit the power dissipation a maximum frequency must not be exceeded. At the same time, it is desirable to minimize the amount of line-conducted high-frequency interference on the supply voltage lines by selecting the highest possible triggering frequency in order to achieve a better filtering effect in the low-pass filter. Because the power dissipation at the electrical components changes as a function of the pulse duty factor, provision is made for the triggering frequency of the pulse width modulation signal also to be selected as a function of the pulse duty factor. The particular triggering frequency is adapted, in this context, to the power dissipation respectively allowed for the electrical component, preferably to its maximum permissible power dissipation. Provision can thus be made at specific pulse duty factors for high triggering frequencies that, at different pulse duty factors, would cause the permissible power dissipation in the electrical component to be exceeded.

According to a further aspect of the present invention, a control circuit for triggering an electric motor with the aid of a pulse width modulation signal is provided. The pulse width modulation signal has a triggering frequency and a pulse duty factor, the electric motor being operable with a supply voltage controllable via a switching device. A control module generates the pulse width modulation signal in order to switch the switching device in accordance with the pulse duty factor. A low-pass filter circuit is provided which filters the supply voltage in order to reduce voltage fluctuations caused on a supply voltage line by the pulse width modulation signal. The control module generates the triggering frequency of the pulse width modulation signal as a function of the pulse duty factor.

The advantageous result of this is that for a particular pulse duty factor, the triggering frequency selected can be sufficiently high that line-conducted interference on the supply voltage line for the electric motor can be reduced.

The result of the low-pass filter circuit is that the supply voltage is smoothed, it being substantially the case that the higher the frequency of the voltage fluctuations in the supply voltage line, the more the voltage fluctuations are smoothed.

Provision can be made for the control module to trigger the switching device with a triggering frequency of the pulse width modulation signal such that a power dissipation of a component in the filter circuit and/or switching device does not exceed a maximum permissible value. The upper limit of the triggering frequency is thus defined in each case by the maximum acceptable power dissipation for each of the components in the filter circuit or switching device, and as a function of the pulse duty factor.

### BRIEF DESCRIPTION OF THE DRAWINGS

FIG. 1 shows a diagram of a control circuit according to the present invention.

FIG. 2 shows a diagram indicating the correlation between the fluctuations on the supply voltage line and the period length at the same pulse duty factor.

### DETAILED DESCRIPTION

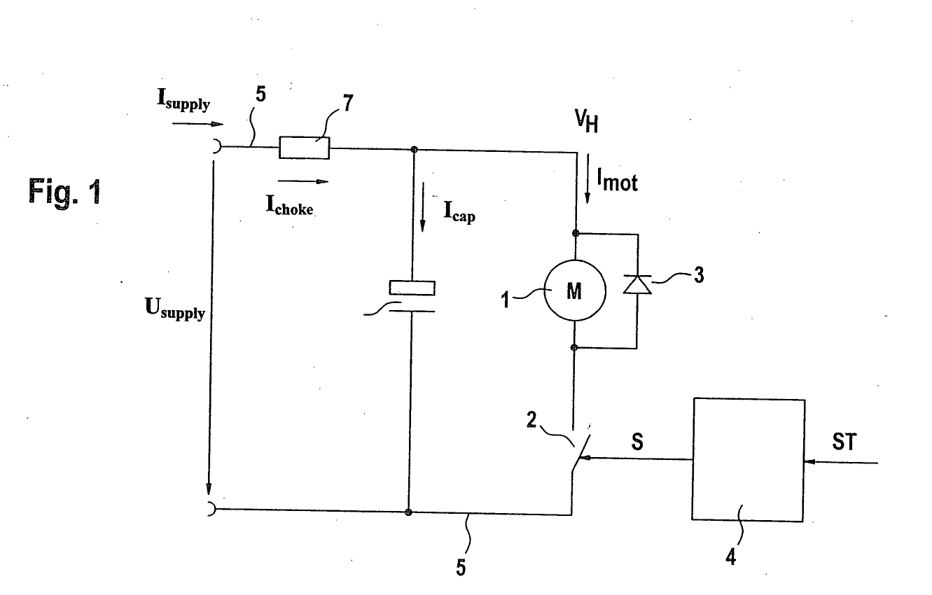

FIG. 1 depicts a triggering system of an electric motor 1. Electric motor 1 is controlled with the aid of a pulse width modulation signal S that is applied to a switching device 2. For that purpose, electric motor 1 and switching device 2 are connected in series between a high supply voltage potential V_{H} and a ground potential GND. The pulse width modulation signal makes possible stepless triggering of electric motor 1.

In order to avoid voltage spikes at switching device 2, due to the inductance of electric motor 1, when switching device 2 is switched off, a freewheeling diode 3 is provided parallel to electric motor 1 and diverts a freewheeling voltage that is greater than the high supply voltage VH.

Pulse width modulation signal S has a triggering frequency f and a pulse duty factor Tv. Triggering frequency f defines a period length T after which pulse width modulation signal S cyclically repeats. Pulse duty factor Tv defines the ratio between the on-time during the period length of pulse width modulation signal S and the entire period length. In other words, the greater pulse duty factor Tv, the greater the proportion of time during which switching device 2 is closed, and the longer the supply voltage is applied to electric motor 1 during a period T. The on-time during a period can be varied arbitrarily by selecting pulse duty factor Tv, so that electric motor 1 can thereby be steplessly triggered.

Pulse width modulation signal S is made available to switching device 2 by a control module 4 that generates pulse width modulation signal S as a function of a predetermined control input that is received from a control signal line ST. The control input can be received from a control device (not shown) or a data network (e.g. a CAN network).

Control module 4 usually has a microcontroller that ascertains triggering frequency f and pulse duty factor Tv from the control input, and generates pulse width modulation signal S. The switching on and off of switching device 2, which in the embodiment shown is embodied as a field-effect power transistor 2, causes steep voltage edges at electric motor 1. These result in voltage fluctuations, at the triggering frequency and its harmonic frequencies, on supply voltage lines 5. In order to relieve the supply voltage system of these voltage fluctuations, a low-pass filter circuit S is provided that has an electrolytic capacitor 6 and a choke coil 7. Low-pass filter circuit S smoothes the voltage fluctuations present on supply voltage lines 5. The higher the frequency of the voltage fluctuations on supply voltage lines 5, the better low-pass filter circuit S filters the voltage fluctuations. The voltage fluctuations substantially have frequencies that are defined by the fundamental frequency of the triggering frequency of the pulse width modulation signal S and by its multiples, i.e. its harmonics.

If the triggering frequency is increased, the low-pass filter circuit then works more effectively and filters a larger high-frequency portion of the voltage fluctuations out of supply voltage lines 5. At the same time, however, the power dissipation in electrolytic capacitor 6 and choke coil 7 rises as the frequency increases. Because the power dissipation is limited at the top end by the smallest value of the maximum power dissipations for each of the components on supply voltage lines 5, triggering frequency f cannot be increased arbitrarily.

The power dissipation of each of the components, (electrolytic capacitor 6 and choke coil 7) is additionally dependent on pulse duty factor Tv of pulse width modulation signal S. The power dissipation of electrolytic capacitor 6 will be determined below. Let it be assumed initially that the currents I_{supply}, I_{choke}, and Iₘ are constant. Then
I_{supply}=Iₘ*T_{V},
where Tᵥ indicates the pulse duty factor and can assume a value in the range from 0 to 1. The off-time of the switching device is then defined as
I_{cap}=I_{choke},
where I_{cap} represents the current through electrolytic capacitor 6.

The voltage swings at electrolytic capacitor 6 are defined in accordance with the following equations:

$$d {U}_{cap +} = \frac{1}{C} * {\int }_{0}^{T} {I}_{cap} ⅆ t = \frac{1}{C} {I}_{cap} ( 1 - Tv ) * T \qquad ( 1 )$$

where

$$T ( = \frac{1}{f} )$$

corresponds to the period length of pulse width modulation signal S. The on-time of switching device 2 is defined as
I_{cap}=I_{choke}−Iₘ (2)
and

$$d {U}_{cap -} = \frac{1}{C} * {\int }_{0}^{T} {I}_{cap} ⅆ t = \frac{1}{C} {I}_{cap} ( Tv - 1 ) * T \qquad ( 3 )$$

dU_{cap+} and dU_{cap} are proportional to the period length of pulse width modulation signal S, i.e. the voltage swing at electrolytic capacitor 6 can be diminished by an increase in triggering frequency f. Considering dU_{cap+}, where
I_{cap}=I_{choke}=Tᵥ*I_{mod}, (4)
the result is

$$\begin{matrix}d {U}_{cap +} = \frac{1}{C} * {\int }_{0}^{T} {I}_{cap} ⅆ t \\ = \frac{1}{C} {I}_{cap} ( 1 - Tv ) * T \\ = \frac{1}{C} * Tv * ( 1 - Tv ) * T * {I}_{m} .\end{matrix} \qquad ( 5 )$$

For a motor current
Iₘ=k1*Uₘ²=k1*(Tᵥ*U_{batt})²=k2*Tᵥ² (6)
where k1 and k2 are constant, what is obtained is

$$d {U}_{cap +} = \frac{1}{C} * {Tv}^{3} * ( 1 - Tv ) * k2 * T , \qquad ( 7 )$$

which yields

$${P}_{v} \approx {Tv}^{2} * \frac{1}{T} \approx {Tv}^{2} \cdot f \qquad ( 8 )$$

for the electrical power dissipation Pᵥ.

It is apparent that power dissipation Pᵥ is substantially proportional to the square of pulse duty factor Tv, and proportional to triggering frequency f. The amount of line-conducted interference, however, is not only dependent on the triggering frequency but also substantially dependent on the pulse duty factor, in which context the amount of harmonics can vary considerably depending on the pulse duty factor selected. The amount of harmonics is relatively low at a pulse duty factor of 0.5, for example, and increases considerably as the pulse duty factor decreases or increases. Because the low-pass filter circuit cannot completely filter out the harmonics, a portion remains behind that is present as high-frequency line-conducted interference in the supply voltage system.

Using equations (7) and (8) it is possible to implement, depending on pulse duty factor Tv, triggering frequencies that have elevated electrical power dissipations as compared with a constant triggering frequency f, but nevertheless have advantageous characteristics in terms of line-conducted interference.

Control module 4 is configured in such a way that triggering frequency f of pulse width modulation signal S is modified depending on the selected pulse duty factor Tv, which is defined substantially by control input ST. According to the present invention, therefore, at a very low pulse duty factor Tv, the square of which influences power dissipation Pᵥ, triggering frequency f is considerably elevated in order to improve the filtering effect of low-pass filter S. The elevation in triggering frequency f is governed by the maximum permissible power dissipation of the components present in the low-pass filter, that dissipation being defined substantially by the component having the lowest maximum power dissipation value. In other words, triggering frequency f that is selected causes the power dissipation of the circuit as a whole to approach its permissible maximum.

At a greater pulse duty factor Tv, power dissipation Pv is also considerably higher, so that triggering frequency f must be reduced.

Essentially, the respective triggering frequency f corresponding to power dissipations Pᵥ of the components used in the motor circuit must be selected so that at the given pulse duty factor Tv, the maximum component-dependent power dissipation value is not exceeded for any component. Particular consideration must be given in this context to the components of the low-pass filter circuit, and to field-effect power transistor 2 and freewheeling diode 3.

The triggering frequencies should preferably be selected so that at a triggering frequency of 20 kHz, the maximum possible power dissipation of the circuit as a whole is not exceeded at any pulse duty factor.

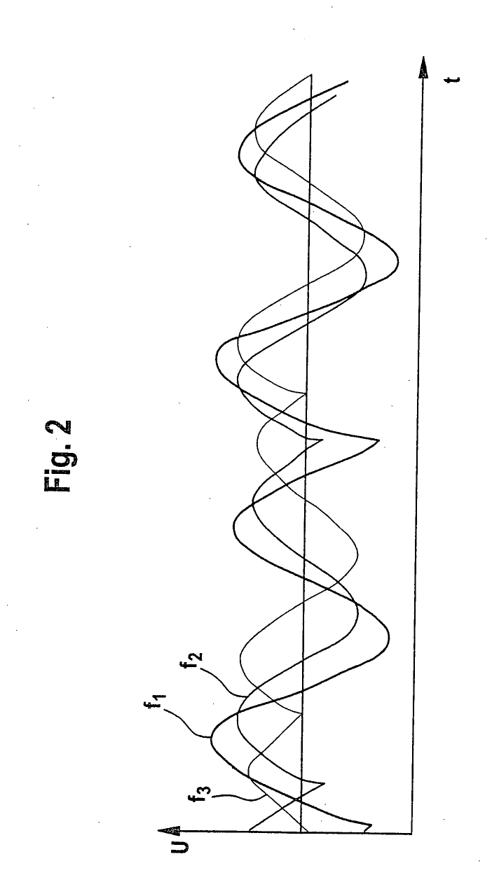

FIG. 2 depicts the voltage profiles on supply voltage line 5 for various triggering frequencies f1, f2, f3. There is an evident decrease in the amplitude of the voltage fluctuations on supply voltage lines 5 with increasing frequency. The line-conducted interference can thus be reduced by increasing triggering frequency f of pulse width modulation signal S.

1.-6. (canceled)

7. A method for triggering an electric motor with a pulse width modulation signal including a triggering frequency and a pulse duty factor, comprising:
controlling the electric motor as a function of the pulse duty factor;
supplying the electric motor with power via a supply voltage line;
providing at least one electrical component for low-pass filtering voltage fluctuations caused on the supply voltage line by the pulse width modulation signal; and
modifying the triggering frequency as a function of the pulse duty factor.

8. The method as recited in claim 7, further comprising:
adapting the triggering frequency as a function of the pulse duty factor in such a way that a maximum permissible power dissipation in the at least one electrical component is not exceeded.

9. The method as recited in claim 7, further comprising:
adapting the triggering frequency as a function of the pulse duty factor in such a way that the triggering frequency is selected to be as high as possible, in order to achieve better filtering of the voltage fluctuations on the supply voltage line.

10. A control circuit for triggering an electric motor via a pulse width modulation signal including a triggering frequency and a pulse duty factor, comprising:
a switching device via which the electric motor is operable with a supply voltage;
a low-pass filter circuit for filtering the supply voltage in order to reduce voltage fluctuations caused on a supply voltage line by the pulse width modulation signal; and
a control module for generating the pulse width modulation signal in order to switch the switching device in accordance with the pulse duty factor, wherein:
the control module generates the triggering frequency of the pulse width modulation signal as a function of the pulse duty factor.

11. The triggering circuit as recited in claim 10, wherein:
the control module triggers the switching device with the triggering frequency such that a power dissipation in at least one of the low-pass filter circuit and the switching device does not exceed a maximum permissible value.

12. The triggering circuit as recited in claim 10, wherein:
the low-pass filter circuit includes at least one of a capacitor and a coil.
